(19) United States
(12) Patent Application Publication
(10) Pub. No.: US 2013/0218649 A1
(43) Pub. Date: Aug. 22, 2013

(54) SINGLE DEVICE LOYALTY CONSOLIDATION PLATFORM AND DATA SYNCHRONIZATION

(71) Applicant: BRYAN R. BEAL, (US)

(72) Inventor: BRYAN R. BEAL, (US)

(21) Appl. No.: 13/539,728

(22) Filed: Jul. 2, 2012

Related U.S. Application Data
(60) Provisional application No. 61/502,894, filed on Jun. 30, 2011.

(51) Int. Cl. G06Q 30/02

(52) U.S. Cl. CPC G06Q 30/0229
USPC 705/14.3

(57) ABSTRACT

The consolidated consumer service platform replaces multiple loyalty, coupon, ticket, gift, membership and any other products that use a unique identifier (numeric, alphanumeric, barcode, magnetic stripe, RFID, NFC, etc.) with a single device and single unique identifier (which may also be numeric, alphanumeric, barcode, magnetic strip, RFID, NFC, etc.) and manages synchronization of consumer demographic information, existing loyalty memberships, and new enrollments—all automatically and electronically. The platform and data synchronization of the consolidated consumer service system of the present invention are important and novel components of the technology in addition to and in combination with the devices which can be used to store and communicate the unique consumer identifier.

### RELATED APPLICATIONS

This application claims priority to U.S. Provisional Patent Application No. 61/502,894, filed on Jun. 30, 3011. This application also claims priority to U.S. patent application Ser. No. 12/248,401, filed on Oct. 9, 2008 and U.S. patent application Ser. No. 12/248,428, filed on Oct. 9, 2008. All of the above-referenced patent applications are incorporated herein by reference in their entirety.

### FIELD OF THE INVENTION

The present disclosure relates, generally, to consumer rewards, loyalty and membership programs, and more particularly, to a consumer tracking and rewards system and method of updating, managing, and storing records of consumer information, including demographic data and purchases with multiple merchants and establishments.

### BACKGROUND OF THE INVENTION

Consumer rewards, loyalty and membership programs are programs sponsored by merchants, services, corporations or clubs as marketing programs that provide consumers with incentives for repeat business, for example to continue purchasing from a particular merchant by providing the consumer with a number of reward or loyalty points based on the number of dollars spent with the merchant. The points may be redeemed by the consumer for cash, merchandise, coupons, or discounts once the consumer has reached a certain point threshold. These programs are typically implemented by merchants asking consumers to complete a paper or online application at the point of sale or elsewhere and thereby issuing the consumer a merchant-branded rewards card which the consumer must present with payment at the time of each purchase with the retailer in order to obtain reward points for their purchases. Under this current system there are inefficiencies for both consumer and merchant.

The first issue affecting the consumer is that in order to enroll in a merchant rewards program, the consumer must complete an application, usually in paper form, and usually at the point of sale. Many consumers may consider this a hassle and may choose not to participate. Other consumers may also view this as an unnecessary step in the point of sale process causing a delay in each consumer's transaction time.

Another problem affecting the consumer is that consumers, who choose to enroll in a multitude of merchant rewards programs, are expected to carry a separate card for each merchant or rewards program for which the consumer is enrolled. If the consumer does not have the rewards card at the time of a purchase, the consumer may not receive the point rewards for the purchase and the merchant misses an opportunity to gain valuable demographic and consumer spending data.

Merchants also encounter difficulties under the current system. The current system can be very expensive to implement, thus eliminating the option for smaller merchants to offer a rewards program. Larger merchants may not see as much return on investment because the process is so cumbersome for consumers to join and participate. Much of the merchant benefit is lost if consumers are not likely to enroll or to carry and use the rewards card. The terms “rewards”, “loyalty” and “membership” are used synonymously herein, and include and mean any program or plan whereby a consumer of goods or services is acknowledged or rewarded or recognized for his or her purchases from a business such as a retailer or service provider. For example, a consolidated consumer rewards system may include any program which enables, acknowledges, rewards (monetarily or otherwise) or tracks the purchases of any consumer of any goods or services. As used herein, the term “merchant” refers to any provider or seller of any goods or services, whether retail, wholesale or business-to-business. As used herein, the term “consumer” means any purchaser of goods or services, whether any individual or business entity, or for personal or commercial use.

A problem affecting both merchants and consumers is that consumers rarely update their addresses with merchants. If a consumer moves to a new address they may not receive the coupons, catalogs, and other incentives that are often mailed to the consumer to encourage them to visit the merchant. Merchants therefore spend money mailing these coupons and catalogs to the wrong people and consumers do not see the benefits they were promised.

### SUMMARY OF THE INVENTION

The consolidated consumer service platform replaces multiple loyalty, coupon, ticket, gift, membership and any other products that use a unique identifier (numeric, alphanumeric, barcode, magnetic stripe, RFID, NFC, etc.) with a single device and single unique identifier (which may also be numeric, alphanumeric, barcode, magnetic strip, RFID, NFC, etc.) and manages synchronization of consumer demographic information, existing loyalty memberships, and new enrollments—all automatically and electronically. The platform and data synchronization of the consolidated consumer service system of the present invention are important and novel components of the technology in addition to and in combination with the devices which can be used to store and communicate the unique consumer identifier.

As referred to herein, the term “card issuer” includes “mobile phone operator” or any other provider of wireless data communication and transaction services and related technologies.

### DESCRIPTION OF THE DRAWINGS

FIG. 1 is a chart describing the consolidated consumer services system ecosystem.

FIG. 2 is a chart describing the consolidated consumer services system integration.

FIG. 3 is a chart describing the consolidated consumer services system synchronization.

FIG. 4 is a chart describing the consolidated consumer services system services.

FIG. 5 is a chart describing the consolidated consumer services system capabilities.

### DETAILED DESCRIPTION OF PREFERRED AND ALTERNATE EMBODIMENTS

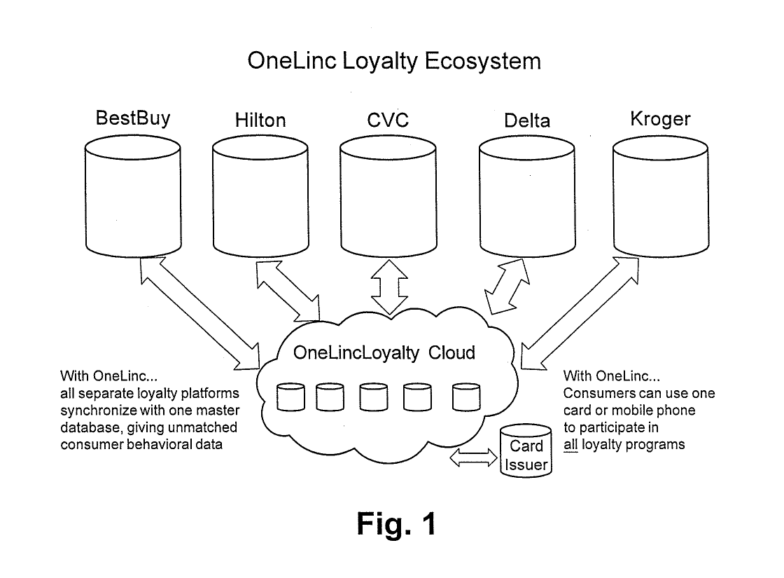

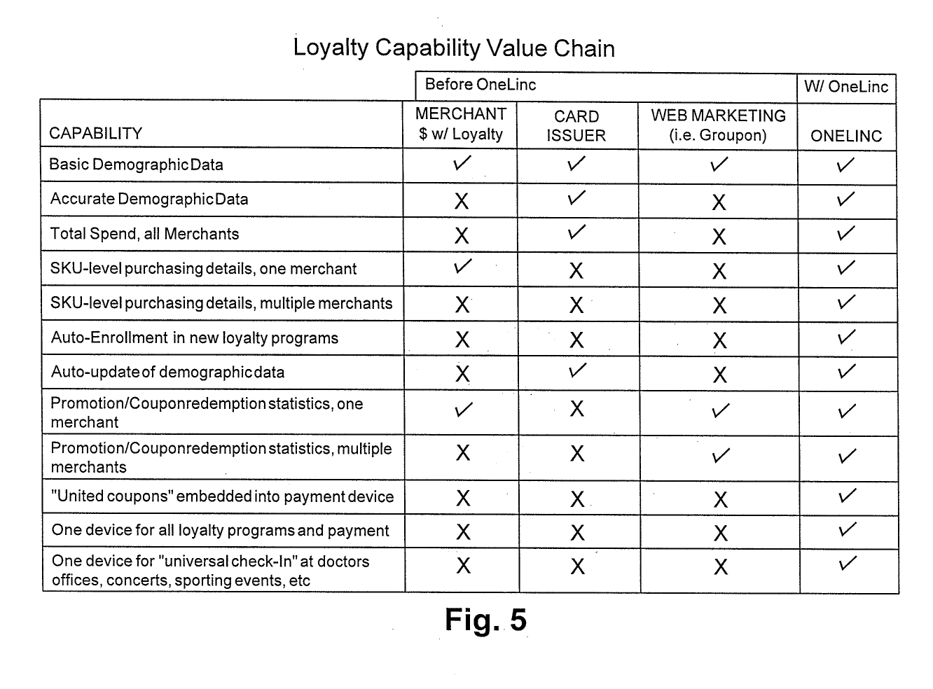

The consolidated consumer services system (hereinafter referred to as “CCSS”) of the present invention maintains a central database repository which synchronizes consumer demographic data including, but not limited to: name; address; email; telephone number; gender; age; spending patterns; previous addresses; loyalty/rewards program numbers; and purchasing data (including individual products) which currently exist across multiple databases. Specifically, the CCSS identifies users by their unique customer number, which may be any combination of characters and represented via any unique identifier including barcode, magnetic strip, RFID, NFC, etc., and matches that unique customer number to multiple merchant loyalty numbers and any other unique identifier which may include, among others, a gift card number, ticket number, membership number, coupon number, etc. The CCSS can support any payment device which can store a unique identifier, such as, for example, cards (mag stripe, barcode, etc.) or mobile phones (NFC, RFID). The CCSS can also store an unlimited amount of data which is a significant improvement over existing “smart cards” or other data devices having a finite amount of memory or storage capacity. As shown in FIG. 1, the separate loyalty programs of multiple merchants are synchronized with the CSSS platform so that consumers may use a single card or device to participate in multiple rewards/loyalty programs or other card-based services among multiple merchants. A chart showing the many capabilities of the CSSS is shown in FIG. 5.

### Updated Consumer Information

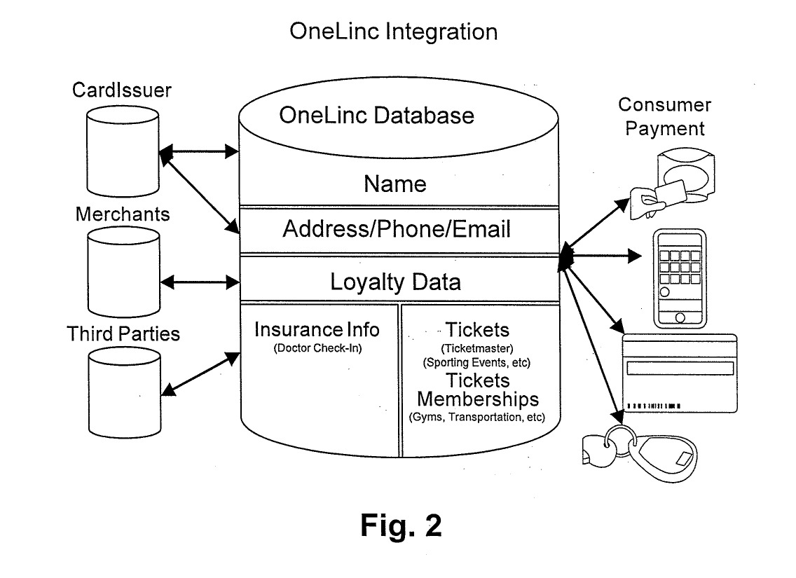

As shown in FIG. 2, the CCSS can optionally integrate its master database of customer records and demographic information with one or many payment company's billing platform to synchronize changes to the consumer's demographic information. If the consumer changes any demographic information with a payment provider (or mobile phone provider), that information is transmitted automatically to the CCSS platform, which then transmits those changes to all other merchant rewards/loyalty programs and other card-based services in which that particular consumer participates. This is handled automatically and electronically via the CCSS platform. Any changes made to the consumer's demographic data within the cardholder database or mobile phone database is transmitted to CCSS electronically via a rule that triggers the update. The consumer may also elect to change their demographic information directly with the CCSS, in which case that information is also electronically submitted to all participating merchants with whom that consumer maintains a relationship therewith (ex., consumer is a member of the merchant's loyalty program, etc.). The CCSS is a pipeline that connects merchants to each other, and also connects merchants to a card issuer or mobile phone provider, and passes any type of consumer information back and forth between all relevant parties.

### Recurring or One-Time Use

The CCSS database has multiple fields for tying or relating other products and/or services to their CCSS unique identification number, including coupons, tickets, insurance information, membership information, and any other items that uses any type of unique identifier as a reference. The various separate identifiers are then replaced by the single CCSS unique identifier. The consumer can tie or relate any of those different identifiers to their CCSS unique identifier, and then present their CCSS-enabled device in lieu of any of the other identifiers. In other words, consumers can tie or relate multiple identification numbers representing a variety of goods and/or services to a single CCSS identification number.

The CCSS can match a consumer's CCSS unique identifier with other identification numbers that remain static, such as a loyalty number such as a frequent flier number, hotel rewards number, or warehouse membership club numbers (shown in FIG. 2). The CCSS can also match a consumer's CCSS unique identifier with one-time identification numbers, such as event or airline tickets, coupons, etc. The CCSS unique identifier replaces multiple, separate identifiers whether recurring or singular. For example, if a consumer purchases a ticket, such as for a concert, sporting event or airline, the consumer can enter their CCSS unique identifier during the purchase of said ticket and use their CCSS device in lieu of a separate paper ticket. The CCSS device can be presented and scanned upon arrival at an event for admission without physically handling a paper ticket. Most entertainment venues and airports are already equipped to scan barcodes so the ability to scan ticket information from a CCSS device would require minimal integration. Also, merchants can transfer merchant coupons directly to the consumer's CCSS device. This may save the merchant advertising dollars. This also benefits consumer's by illuminating the time required to search for and clip specific merchant coupons and also the effort of having to store and have said coupons available at the point of sale.

### Gift Card Consolidation

In addition to maintaining various reward and/or club identification numbers, many consumers have separate gift cards from the same merchant and separate gift cards from multiple merchants. To consolidate such gift cards, a consumer can use the CCSS portal to tie all of those separate gift card numbers to their CCSS unique identifier. The CCSS would transmit this change to the merchant. The consumer could then present their CCSS device in lieu of the gift cards, and the merchant system looks up the CCSS unique identifier and stored value for that unique identifier. Several different merchant gift cards may be contain on the single CCSS device. The CCSS device would maintain the decreasing balance of said gift cards as the consumer makes purchases toward which the gift card value is applied and increase balance of said gift card as consumers add new gift cards. This would benefit the consumer by eliminating the need to carry the physical gift card and it would benefit merchants by potentially decreasing fraud.

### Purchasing Trends

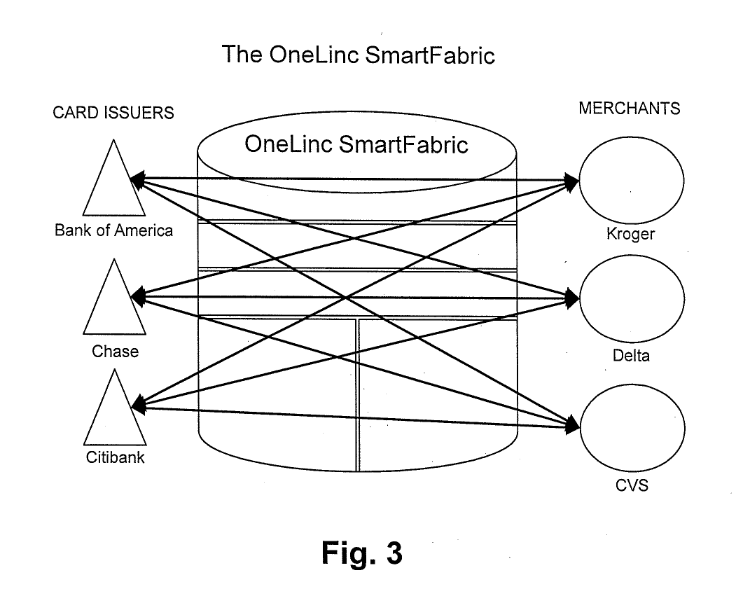

The CCSS also synchronizes and consolidates spending behaviors of individual consumers across multiple merchants within the CCSS database, as shown in FIG. 3. When a consumer purchases items from a participating merchant, the purchase information is stored in said merchant's loyalty database. This information gets transferred to the CCSS, which matches the merchant loyalty number to the consumer's CCSS unique identifier, and stores said purchase information within the CCSS database (identified by barcode, SKU or other product identifier). The CCSS platform then aggregates this data from all participating merchants, and all of the products and/or services purchased by a consumer from multiple merchants are tied to that consumer's CCSS unique identifier and stored within the CCSS platform. This information includes, but is not limited to: total spent by each consumer at each merchant; total spent by all consumers at each merchant; total spent by each consumer at all merchants; item- or SKU-level purchasing details for each consumer; item- or SKU-level purchasing details for all consumers; item- or SKU-level purchasing details for each merchant; item- or SKU-level purchasing details for all merchants; promotion/coupon redemption statistics for each consumer; promotion/coupon redemption statistics for all consumers; promotion/coupon redemption statistics for each merchant; and promotion/coupon redemption statistics for all merchants. The CCSS may transmit this data to other merchants and credit card issuers. This allows merchants to analyze consumer purchase histories so that merchants can tailor advertisements and/or coupons directly to consumers based on each particular consumer's purchase history (from all participating merchants from which consumer does business).

### Automatic Enrollment

The CCSS can also enable automatic enrollment of users into a new merchant loyalty program at the point of sale. When a consumer engages with a merchant and they are not yet a member of said merchant's loyalty program, they may elect to join by using their CCSS device. The CCSS transmits said consumer's demographic information from the CCSS database to the merchant database electronically, thereby eliminating the need for the consumer to manually provide such information directly to the merchant. Any changes to said consumer's information within the CCSS platform, or within a participating and integrated merchant and/or credit card issuer, would trigger an automatic update of that information, which is sent to all participating merchants with whom that consumer does business. This eliminates the need for consumer's to fill out paper based forms or for the merchant to manually enter consumer's information into a computer or check-out device during a sales transaction.

### Other Business Uses

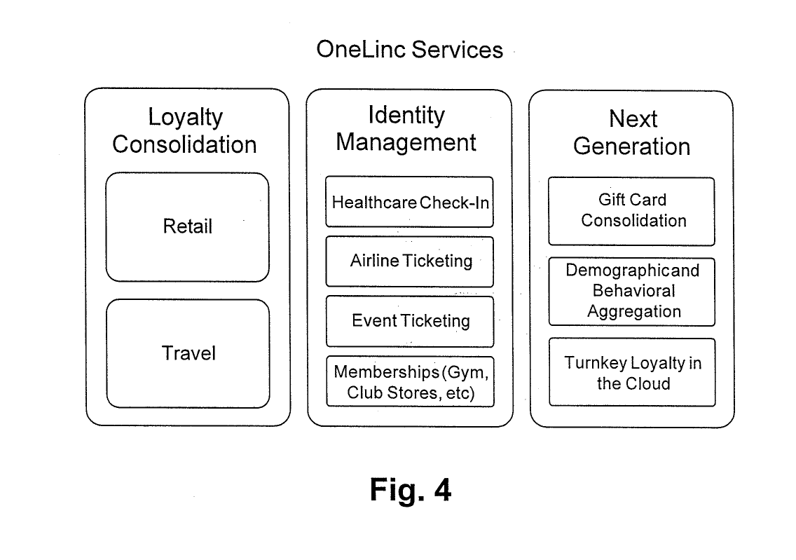

The CCSS can also enable the automatic transmission of a consumer's demographic information to any party with whom the consumer wishes to conduct business and who requires or benefits from having that consumer's information, including, but not limited to: healthcare providers (physicians, physical therapy, hospitals, urgent care facilities, etc.); specialty services (salons, spas, gyms); and any other institution that would otherwise request a consumer provide information manually, as shown in FIG. 4. When a consumer engages with a merchant, and that merchant does not have their up-to-date information, they may elect to join using their CCSS device. The CCSS transmits said consumer's demographic information from the CCSS database to the merchant database electronically, thereby eliminating the need for the consumer to manually provide that information to a merchant. This information can include any data related to that consumer, including, but not limited to: name; address; contact information; insurance identification; personal health information; spending behaviors, and personal activities. Likewise, any changes to said consumer's demographic information within the CCSS platform, or within a participating and integrated payment issuer or other third party data repository would trigger an automatic update of that information sent to all participating merchants or businesses with whom said consumer interacts.

For example, in a healthcare environment, if a consumer changes his/her insurance information, all registered healthcare providers receive the updated information. Also if a consumer visits a healthcare provider for the first time, the consumer may provide all personal information automatically through his/her CCSS device. A kiosk may be provided at one or more healthcare providers for recording and checking-in patients as they arrive. The CCSS device may be scanned at said kiosk, providing instant patient information such as name, address, insurance provider, member number, and emergency contact information which is typically updated or confirmed upon arrival at a healthcare facility.

In another example, a consumer may also sign up at a new gym with his/her CCSS device without having to fill out the traditional paperwork. Most gyms typically use barcode scanners or proximity cards. The CCSS device would become the consumer's gym check-in device which eliminates the need to carry an additional membership card. Likewise, bus and subway passes can be assigned to a consumer's CCSS device to replace passes or cards.

A unique CCSS identification number may also be integrated with various proprietary hardware and/or software devices. For example, many restaurants are moving toward electronic reservations. A consumer's CCSS device can be integrated with the existing restaurant POS system so that reservations can be made via a consumer's CCSS account or mobile device.

What is claimed is:

1. A consolidated consumer services system comprising:
a consumer services platform comprising a combination of hardware and software and data communications devices operative to receive, store and transmit consumer data between multiple consumers and multiple merchants;
a device selected from the group of: credit card; membership card with barcode; membership card with magnetic stripe, and cellular telephone;
a unique consumer number assigned to each consumer which resides on the device;
the consumer services platform configured to receive multiple identification numbers for each consumer, the multiple identification numbers representing membership in consumer rewards programs, club membership, merchant gift card values or a combination thereof and relate each of the multiple identification numbers to the unique consumer number assigned to each consumer;
the consumer services platform configured and programmed to receive, store and consolidate total purchase information for individual consumers across a plurality of merchants;
the consumer services platform configured and programmed to receive, store and consolidate SKU-level purchasing information for individual consumers across a plurality of merchants;
the consumer services platform configured and programmed to receive and store new or updated consumer information selected from one or more of name, address, and telephone number, and transmitting said new or updated consumer information to the multiple merchants.

2. The consolidated consumer services system of claim 1, wherein coupons may be transmitted from one or more of the multiple merchants to the device of one or more of the multiple consumers.

3. The consolidated consumer services system of claim 1, wherein the consolidated consumer total purchase and total SKU-level purchasing information can be shared among the multiple merchants.

4. The consolidated consumer services system of claim 1, wherein event ticket information may be stored on the device in lieu of a physical event ticket.

5. The consolidated consumer services system of claim 1, wherein two or more merchant gift cards for the same merchant are consolidated on the device.

6. The consolidated consumer services system of claim 1, wherein two or more merchant gift cards for different merchants can be stored on the device.

7. The consolidated consumer services system of claim 1, wherein medical insurance information can be stored on the device and transmitted to healthcare providers.

8. A consolidated consumer services system comprising:
a consolidated consumer services platform comprising a combination of hardware, software and data communications devices operative to receive, store and transmit data between a plurality of consumers and a plurality of merchants;
a plurality of unique consumer identification numbers, one of the plurality of unique consumer identification numbers assigned to each of the plurality of consumers;
wherein any change to consumer address or telephone number received by the consolidated consumer services platform is transmitted to each of the plurality of merchants;
wherein consumer purchase data from each of the plurality of merchants for each of the plurality of consumers is stored within a database in the consolidated consumer services platform; and
wherein merchant consumer rewards program information, event ticket information, airline ticket information, gift card information, healthcare insurance information, merchant coupons, and membership card information can be stored within the consolidated consumer services platform for each of the plurality of consumers.

9. The consolidated consumer services system of claim 8, wherein the unique identification number is stored on a consumer credit card.

10. The consolidated consumer services system of claim 8, wherein the unique identification number is stored on a cellular telephone.

11. The consolidated consumer services system of claim 8, wherein the consumer purchase data includes SKU-level data.

12. The consolidated consumer services system of claim 8, wherein consumer purchase data from each of the plurality of merchants for each of the plurality of consumers is shared among the plurality of merchants.

13. The consolidated consumer services system of claim 8, wherein multiple gift cards from the same merchant can be consolidated in the consolidated consumer services platform.

14. The consolidated consumer services system of claim 8, wherein once a consumer is assigned a unique identification number, the consumer may enroll in a merchant's reward program by providing the unique identification number to said merchant.

15. A consolidated consumer services system comprising:
a combination of hardware, software and communications devices operative to facilitate information transfer between a plurality of consumers and a plurality of merchants, the combination of hardware, software and communications devices comprising:
a consumer services platform configured and programmed to maintain multiple consumer numbers which are used to identify each of the plurality of consumers, and to correlate each of the plurality of consumers with each of a plurality of merchant rewards programs of the plurality of merchants with which the consumer has enrolled;
the consumer services platform operative to receive and store item level consumer purchasing information from each of the plurality of merchants for each of the plurality of consumers;
wherein the item level consumer purchasing information is transmitted and shared between the consumer services platform and the plurality of merchants; and
wherein consumer address and telephone number updates are transmitted and shared between the consumer services platform and the plurality of merchants.

16. The consolidated consumer services system of claim 15, wherein the consumer services platform is operative to receive and consolidate merchant gift card information for each of the plurality of consumers.

17. The consolidated consumer services system of claim 15, wherein the consumer services platform is operative to receive, store and transmit event ticket information, insurance information, and coupon information.

18. The consolidated consumer services system of claim 15, wherein each of the consumer number assigned to each of the plurality of consumers is stored on a credit card issued to the consumer.

19. The consolidated consumer services system of claim 15, wherein the plurality of merchants may transmit coupons to the plurality of consumers via the consumer services platform.

20. The consolidated consumer services system of claim 15, wherein the consumer services platform can store an unlimited amount of data.
